(19) United States
(12) Patent Application Publication
(10) Pub. No.: US 2018/0254059 A1
(43) Pub. Date: Sep. 6, 2018

(54) DISK-LIKE MAGNETIC RECORDING MEDIUM AND MAGNETIC RECORDING AND REPRODUCING DEVICE

(71) Applicant: Kabushiki Kaisha Toshiba, Tokyo (JP)

(72) Inventors: Takuya Matsumoto, Tokyo (JP); Akira Watanabe, Kawasaki Kanagawa (JP)

(21) Appl. No.: 15/681,592

(22) Filed: Aug. 21, 2017

(30) Foreign Application Priority Data
Mar. 3, 2017 (JP) 2017-040688

(51) Int. Cl. G11B 5/31; G11B 5/39; G11B 5/245; G11B 5/48

(52) U.S. Cl. CPC G11B 5/3113; G11B 5/4806; G11B 5/245; G11B 5/3922

(57) ABSTRACT

According to one embodiment, a disk-like magnetic recording medium includes a disk-like substrate, a first soft magnetic layer provided on the disk-substrate, a nonmagnetic spacer layer provided on the first soft magnetic layer, a second soft magnetic layer provided on the nonmagnetic spacer layer and antiferromagnetically exchange-coupled with the first soft magnetic layer via the nonmagnetic spacer layer, a magnetic recording layer provided on the second soft magnetic layer, wherein strength of an exchange coupling magnetic field Hbias decreases from an inner circumferential area toward an outer circumferential area of the disk-like magnetic recording medium.

### CROSS-REFERENCE TO RELATED APPLICATIONS

This application is based upon and claims the benefit of priority from Japanese Patent Application No. 2017-040688, filed Mar. 3, 2017, the entire contents of which are incorporated herein by reference.

### FIELD

Embodiments described herein relate generally to a disk-like magnetic recording medium and a magnetic recording and reproducing device.

### BACKGROUND

Among magnetic recording and reproducing devices, not only high recording capacity but also high data access performance is required of magnetic recording and reproducing devices which are designed for enterprises. In particular, an improvement of linear recording density (BPI) is required of sequential access performance.

In a magnetic recording and reproducing device using a conventional magnetic recording medium, the problem is that performance of a write operation in a high-speed transfer operation tends to decline in an outer circumferential area where a circumferential speed is high and this prevents an improvement of BPI.

To solve this problem, a method of compensating the decline of the performance of the write operation in the outer circumferential area by increasing a recording current to be applied to a recording head and increasing a magnetic flux to be produced from the recording head has been proposed.

However, the increase of the recording current leads to magnetic saturation of a magnetic shield which surrounds the magnetic head. For example, in a circumferential direction, a magnetic field gradient is decreased to deteriorate an S/N ratio due to magnetic saturation of a write shield, and in a radial direction, recorded information of adjacent tracks or tracks over a wide region is degraded or erased due to magnetic saturation of a side shield.

### BRIEF DESCRIPTION OF THE DRAWINGS

FIG. 1 is a sectional diagram showing an example of the structure of a magnetic recording medium of an embodiment.

FIG. 2 is a sectional diagram showing another example of the structure of the magnetic recording medium of the embodiment.

FIG. 3 is a graph showing the relationship of the thickness of a nonmagnetic spacer layer used in the embodiment to Hbias.

FIG. 4 is a schematic diagram showing an example of the structure of a film deposition device for controlling a film thickness.

FIG. 5 is a schematic diagram showing an example of the structure of a film deposition device for controlling a film thickness.

FIG. 6 is a schematic diagram showing an example of the structure of a film deposition device for controlling a film thickness.

FIG. 7 is a schematic diagram showing an example of the structure of a film deposition device for controlling a film thickness.

FIG. 8 is a schematic diagram showing an example of the structure of a film deposition device for controlling a film thickness.

FIG. 9 is a schematic diagram showing an example of the structure of a film deposition device for controlling a film thickness.

FIG. 10 is a schematic diagram showing an example of a magnetic recording and reproducing device to which the magnetic recording medium of the embodiment can be applied.

FIG. 11 is a graph showing the relationship between Hbias of an inner circumferential area and a maximum value of Hbias of an outer circumferential area.

### DETAILED DESCRIPTION

In general, according to one embodiment, a magnetic recording medium has the shape of a disk, and includes a disk-like substrate, a multilayer soft magnetic layer, and a magnetic recording layer.

The multilayer soft magnetic layer used in the embodiment includes a first soft magnetic layer, a nonmagnetic spacer layer, and a second soft magnetic layer which is antiferromagnetically exchange-coupled (AFC) with the first soft magnetic layer via the nonmagnetic spacer layer.

The magnetic recording medium of the embodiment can be divided into the following three types in terms of the strength of the exchange coupling magnetic field and the thickness of the nonmagnetic spacer layer.

In the magnetic recording medium of the first embodiment, the strength of the exchange coupling magnetic field Hbias decreases from the inner circumferential area toward the outer circumferential area of the disk-like magnetic recording medium.

In the magnetic recording medium of the second embodiment, the thickness x of the nonmagnetic spacer layer decreases from the inner circumferential area toward the outer circumferential area.

In the magnetic recording medium of the third embodiment, the thickness x of the nonmagnetic spacer layer increases from the inner circumferential area toward the outer circumferential area.

Further, the second embodiment and the third embodiment are further limited to the extent that the value of the exchange coupling magnetic field Hbias changes periodically with respect to the thickness x of the nonmagnetic spacer layer, and a relationship expressed as 0<x≤a is satisfied in the second embodiment, and a relationship expressed as a≤x<b is satisfied in the third embodiment, where a is a thickness of the nonmagnetic spacer layer when the exchange coupling magnetic field Hbias has a maximum value (first peak), c is a thickness of the nonmagnetic spacer layer when the exchange coupling magnetic field Hbias has a maximum value (second peak) after the first peak, and b is a thickness of the nonmagnetic spacer layer when the exchange coupling magnetic field Hbias has a minimum value between the first peak and the second peak.

Here, the exchange coupling magnetic field Hbias represents the degree of antiferromagnetic coupling between the first soft magnetic layer and the second soft magnetic layer.

The exchange coupling magnetic field Hbias can be measured by a vibrating sample magnetometer (VSM) manufactured by, for example, Toei Industry Co., Ltd. After the first soft magnetic layer, the nonmagnetic spacer layer, and the second soft magnetic layer are sequentially formed on the substrate.

Note that, for example, when a disk-like magnetic recording medium having an opening is divided into an area including an opening edge, an area including an outer edge, and an intermediate area therebetween, the inner circumferential area corresponds to the area including the opening edge. Further, the outer circumferential area corresponds to the area including the outer edge.

It is possible to combine the first embodiment with the second embodiment or combine the first embodiment with the third embodiment.

In the first embodiment, the strength of the exchange coupling magnetic field can be gradually reduced from the inner circumferential area toward the outer circumferential area.

In the second and third embodiments, the thickness of the nonmagnetic spacer layer can be gradually reduced or gradually increased from the inner circumference toward the outer circumference.

According to the embodiments, it is possible, by reducing Hbias from the inner circumferential area toward the outer circumferential area of the magnetic recording medium or reducing or increasing the thickness of the nonmagnetic spacer layer from the inner circumference toward the outer circumference in a range where Hbias can be reduced, to prevent the decline of the performance of the write operation in the high-speed transfer operation and improve the linear recording density in the outer circumferential area of the disk-like magnetic recording medium while maintaining or improving the capacity.

Embodiments will be described hereinafter with reference to the accompanying drawings.

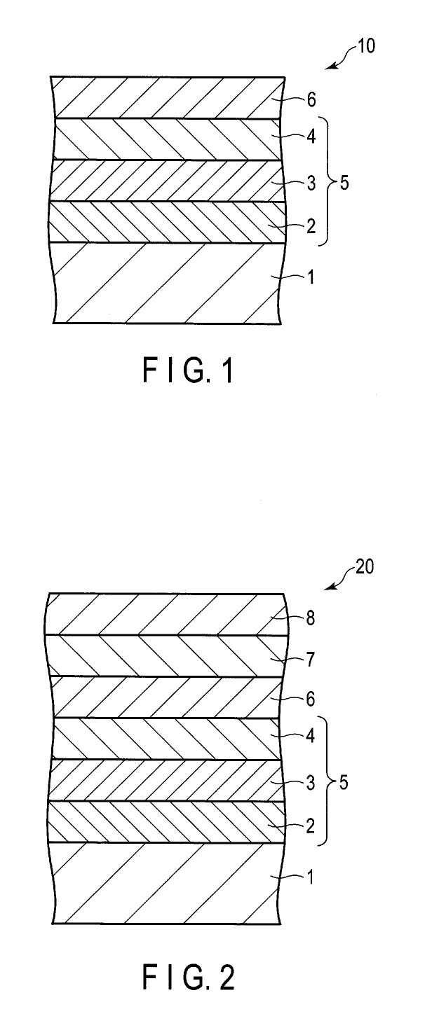

FIG. 1 is a sectional diagram showing an example of the structure of a magnetic recording medium of an embodiment.

As shown in the drawing, a magnetic recording medium 10 includes a substrate 1, a soft magnetic undercoating layer (SUL) 5 which includes a first soft magnetic layer 2, a nonmagnetic spacer layer 3, and a second soft magnetic layer 4 which is antiferromagnetically coupled (AFC) via the nonmagnetic spacer layer 3 sequentially on the substrate 1, and a magnetic recording layer 6 on the soft magnetic undercoating layer (SUL) 5.

As the substrate, a glass substrate, an Al alloy substrate, a ceramic substrate, a carbon substrate, a single crystalline Si substrate having an oxidized surface, or the like can be used.

As the first soft magnetic layer, a Co alloy containing Co and at least one of Zr, Hf, Nb, Ta, Ti and Y such as a CoZr alloy, a CoZrNb alloy or a CoZrTa alloy can be used.

As the nonmagnetic spacer layer, Ru, a Ru alloy, Pd, Cu, Pt or the like can be used.

As the second soft magnetic layer, a Co alloy containing Co and at least one of Zr, Hf, Nb, Ta, Ti and Y such as a CoZr alloy, a CoZrNb alloy or a CoZrTa alloy can be used. The composition of the first soft magnetic layer may be the same as that of the second soft magnetic layer and may also be different from that of the second soft magnetic layer.

As the magnetic recording layer, a material mainly containing Pt and either one of Fe and Co can be used.

For example, the magnetic recording layer has a granular structure which contains CoCrPt, FePt, CoPt, CoCrTa, SmCo or TbFeCo, and an oxide such as SiO₂ or TiO₂ as a grain boundary segregation material between the magnetic grains.

FIG. 2 is a sectional diagram showing another example of the structure of a magnetic recording medium of an embodiment.

As shown in the drawing, except that an intermediate layer 6 is further provided between the soft magnetic undercoating layer 5 and the magnetic recording layer 7, and a protection layer 8 and a lubrication layer 9 are further provided sequentially on the magnetic recording layer 7, the structure of a magnetic recording medium 20 is the same as the structure shown in FIG. 1.

As the intermediate layer, a Ru alloy, a Ni alloy, a Pt alloy, a Pd alloy, a Ta alloy, a Cr alloy, a Si alloy, a Cu alloy or the like can be used.

The protection film contains C.

As the lubricant, perfluoropolyether, fluoroalcohol or fluorinated carboxylic acid can be used.

The magnetic recording medium of the embodiment can be manufactured by the following processes.

Firstly, a substrate is accommodated in a film deposition chamber of a DC magnetron sputtering device, and an air is discharged from the film deposition chamber.

Then, inert gas such as Ar gas is introduced into the film deposition chamber, and a first soft magnetic layer, a nonmagnetic spacer layer, a second soft magnetic layer, an intermediate layer, and a recording layer are sequentially formed on an Al alloy substrate.

After that, a DLC protection layer is formed by a CVD method, and a lubricant is applied by a dipping method.

An example of the process for reducing Hbias from the inner circumferential area toward the outer circumferential area of the disk-like magnetic recording medium will be described below.

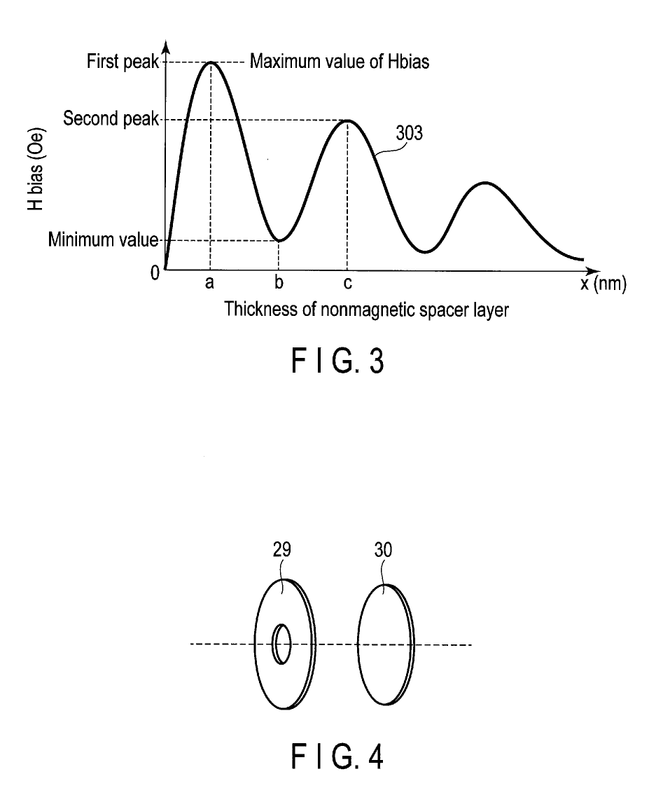

FIG. 3 is a graph showing the relationship of the thickness of the nonmagnetic spacer layer used in the embodiment to Hbias.

The strength of Hbias relies on the thickness of the nonmagnetic spacer layer and peaks when the nonmagnetic spacer layer has a predetermined thickness as shown in a graph 303.

It is possible, by increasing the thickness x of the nonmagnetic spacer layer from the inner circumferential area toward the outer circumferential area of the disk-like magnetic recording medium in such a manner as to satisfy an inequality defined as a≤x<b, where a is a thickness of the nonmagnetic spacer layer when Hbias has a maximum value (the first peak), c is a thickness of the nonmagnetic spacer layer when Hbias is at the second peak, and b is a thickness of the nonmagnetic spacer layer when Hbias has a minimum value between the first peak and the second peak, to reduce Hbias from the inner circumferential area toward the outer circumferential area of the disk.

It is also possible, by reducing the thickness x of the nonmagnetic spacer layer from the inner circumferential area toward the outer circumferential area of the disk-like magnetic recording medium in such a manner as to satisfy an inequality defined as 0<x≤a, where a is a thickness of the nonmagnetic spacer layer when Hbias has a maximum value, to reduce Hbias from the inner circumferential area toward the outer circumferential area of the disk.

In the magnetic recording medium of the second embodiment, a film thickness control method for forming the nonmagnetic spacer layer whose thickness decreases from the inner circumferential area toward the outer circumferential area will be described with reference to FIGS. 4, 5 and 6.

FIGS. 4, 5 and 6 are schematic diagrams, each showing an example of the structure of a film deposition device for controlling a film thickness.

As shown in FIG. 4, in the film deposition device, a disk substrate 29 of 3.5 inches and a sputtering target 30 whose outer diameter is less than the outer diameter of the disk substrate 29 are opposed to each other. As a film deposition process is performed in this state, the nonmagnetic spacer layer whose thickness decreases from the inner circumferential area toward the outer circumferential area can be formed.

To satisfy the inequality defined as 0<x≤a, it is possible to make adjustments, for example, by setting a sputtering rate to 0.5 nm/s and setting a sputtering time to 2 seconds.

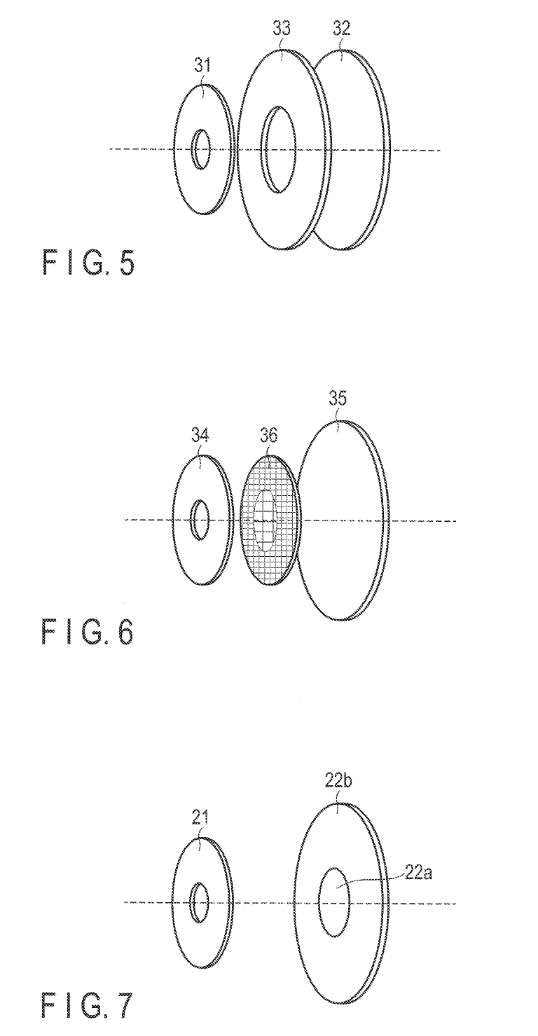

As shown in FIG. 5, in the film deposition device, a disk substrate 31 of 3.5 inches and a sputtering target 32 whose outer diameter is greater than the outer diameter of the disk substrate 31 are opposed to each other, and for example, a disk 33 which is formed of nonmagnetic metal and has a hole in the center is interposed between the disk substrate 31 and the target 32. The inner diameter of the disk 33 is, for example, 42.5 mm to 77.5 mm and should preferably be less than the outer diameter of the disk substrate 31. As a film deposition process is performed in this state, the nonmagnetic spacer layer whose thickness decreases from the inner circumferential area toward the outer circumferential area can be formed. To satisfy the inequality defined as 0<x≤a, it is possible to make adjustments, for example, by setting a sputtering rate to 0.5 nm/s and setting a sputtering time to 2 seconds.

As shown in FIG. 6, in the film deposition device, a substrate 34 of 3.5 inches and a sputtering target 35 whose outer diameter is greater than the outer diameter of the disk substrate 34 are opposed to each other, and a grid-like disk 36 which is formed of nonmagnetic metal is interposed between the disk substrate 34 and the target 35. The outer diameter of the grid-like disk 36 is greater than the outer diameter of the disk substrate 34. The grid size is small in the circumferential area of the disk and is large in the outer circumferential area of the disk. As a film deposition process is performed in this state, the nonmagnetic spacer layer whose thickness decreases from the inner circumferential area toward the outer circumferential area can be formed. To satisfy the inequality defined as 0<x≤a, it is possible to make adjustments, for example, by setting a sputtering rate to 0.5 nm/s and a sputtering time to 2 seconds.

Further, when a film deposition process is performed in the arrangement shown in FIG. 5, it is possible, for example, by using a plurality of chambers and reducing the inner diameter of the disk 33 chamber by chamber, to form the nonmagnetic spacer layer whose thickness decreases gradually from the inner circumferential area toward the outer circumferential area.

When a film deposition process is performed in the arrangement shown in FIG. 5, it is possible, for example, by using a plurality of chambers and reducing the inner diameter of the disk 33 chamber by chamber, to reduce the strength of the exchange coupling magnetic field gradually from the inner circumferential area toward the outer circumferential area.

In the magnetic recording medium of the third embodiment, a film thickness control method for forming the nonmagnetic spacer layer whose thickness increases from the inner circumferential area toward the outer circumferential area will be described with reference to FIGS. 7, 8 and 9.

FIGS. 7, 8 and 9 are schematic diagrams, each showing an example of the structure of a film deposition device for controlling a film thickness.

As shown in FIG. 7, in the film deposition device, a disk-like sputtering target 22b which has an opening in the center, and an oxide layer 22a which is provided in the opening are opposed to a disk substrate 21. The outer diameter of the sputtering target 22b is greater than the outer diameter of the disk substrate 21. The disk-like oxide layer 22a is formed of an oxide such as TiO₂, SiO₂, Al₂O₃ or MgO, and the sputtering target 22b which is formed of the material of the nonmagnetic spacer layer is arranged around the disk-like oxide layer 22a. The outer diameter of the disk-like oxide layer 22a is less than the outer diameter of the disk substrate 21, and should preferably be 42.5 mm to 77.5 mm. As a film deposition process is performed in this state, the nonmagnetic spacer layer whose thickness increases from the inner circumferential area toward the outer circumferential area can be formed. To satisfy the inequality defined as a≤x<b, it is possible to make adjustments, for example, by setting a sputtering rate to 0.5 nm/s and setting a sputtering time to 3 seconds.

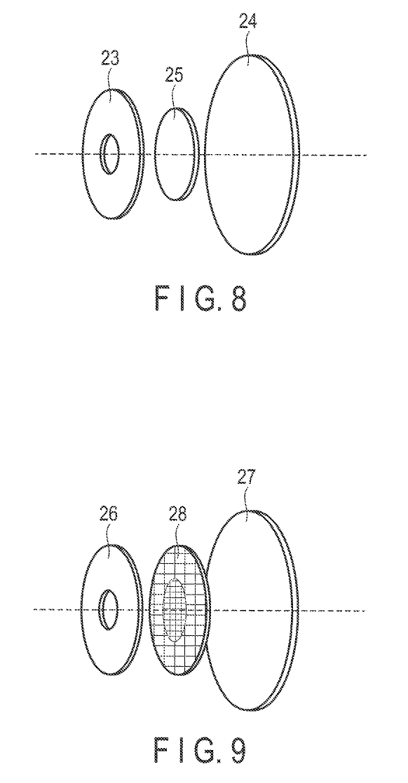

As shown in FIG. 8, in the film deposition device, a disk substrate 23 of 3.5 inches and a sputtering target 24 whose outer diameter is greater than the outer diameter of the disk substrate 23 are opposed to each other, and a disk 25 which is formed of nonmagnetic metal is interposed between the disk substrate 23 and the sputtering target 24. The outer diameter of the disk 25 is less than the outer diameter of the disk substrate 23, and should preferably be 42.5 mm to 77.5 mm. Accordingly, the nonmagnetic spacer layer whose thickness increases from the inner circumferential area toward the outer circumferential area can be formed. To satisfy the inequality defined as a≤x<b, it is possible to make adjustments, for example, by setting a sputtering rate to 0.5 nm/s and setting a sputtering time to 3 seconds.

As shown in FIG. 9, a disk substrate 26 and a sputtering target 27 are opposed to each other, and a grid-like disk 28 which is formed of nonmagnetic metal is interposed between the disk substrate 26 and the sputtering target 27. The outer diameter of the grid-like disk 28 is greater than the outer diameter of the disk substrate 26, and the grid size is large in the circumferential area of the disk and is small in the outer circumferential area of the disk. Accordingly, the nonmagnetic spacer layer whose thickness increases from the inner circumferential area toward the outer circumferential area can be formed. To satisfy the inequality defined as a≤x<b, it is possible to make adjustments, for example, by setting a sputtering rate to 0.5 nm/s and setting a sputtering time to 3 seconds.

Further, when a film deposition process is performed in the arrangement shown in FIG. 8, it is possible, for example, by using a plurality of chambers and increasing the outer diameter of the disk 25 chamber by chamber, to form the nonmagnetic spacer layer whose thickness increases gradually from the inner circumferential area toward the outer circumferential area.

When a film deposition process is performed in the arrangement shown in FIG. 8, it is possible, for example, by using a plurality of chambers and increasing the outer diameter of the disk 25 chamber by chamber, to reduce the strength of the exchange coupling magnetic field gradually from the inner circumferential area toward the outer circumferential area.

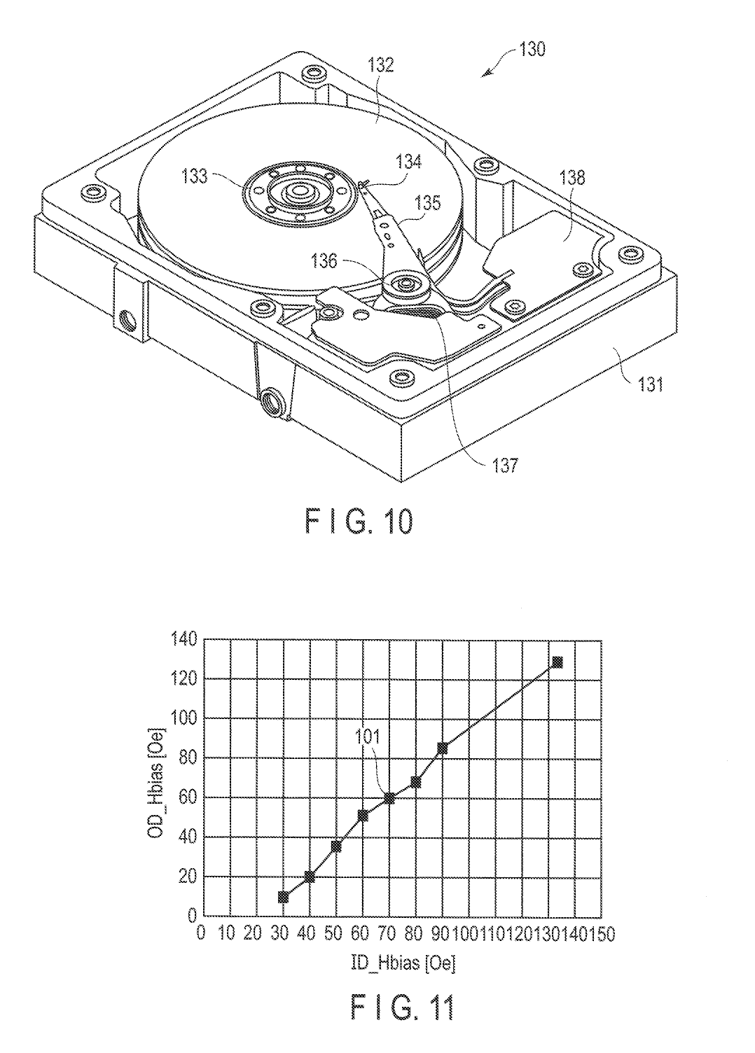

FIG. 10 is a schematic diagram showing an example of a magnetic recording and reproducing device to which the magnetic recording medium of the embodiment can be applied.

As shown in the drawing, a magnetic recording and reproducing device 130 includes a housing 131 which has the shape of a rectangular box whose upper surface is open, and a top cover (not shown) which is secured to the housing 131 with a plurality of screws and closes the upper end opening of the housing.

In the housing 131, a magnetic recording medium 132 of the embodiment, a spindle motor 133 as a driving means which supports and rotates the magnetic recording medium 132, a magnetic head 134 which records and reproduces a magnetic signal with respect to the magnetic recording medium 132, a head actuator 135 which includes a suspension whose tip is provided with the magnetic head 134, and movably supports the magnetic head 134 with respect to the magnetic recording medium 132, a rotating shaft 136 which rotatably supports the head actuator 135, a voice coil motor 137 which rotates and positions the head actuator 135 via the rotating shaft 136, a head amplifier circuit board 138, and the like.

Examples of the embodiments will be described in details.

### EXAMPLES

### Example 1

The magnetic recording medium of the embodiment can be manufactured by the following processes.

Firstly, an Al alloy substrate of 3.5 inches is accommodated in a film deposition chamber of a DC magnetron sputtering device, and an air is discharged from the film deposition chamber.

Next, inert gas such as Ar gas is introduced into the film deposition chamber, and a first soft magnetic layer of CoFeTaZr, a nonmagnetic spacer layer of Ru, a second soft magnetic layer of CoFeTaZr, an intermediate layer of Ru, and a magnetic recording layer of CoCrPt—SiO₂ are sequentially formed on the Al alloy substrate.

After that, a DLC protection layer is formed by a CVD method, a lubricant is applied by a dipping method, and a perpendicular magnetic recording medium of 3.5 inches is obtained.

The obtained perpendicular magnetic recording medium has a structure similar to the structure shown in FIG. 2, and is composed of a multilayer structure of the disk substrate 1, the soft magnetic undercoating layer (SUL) 5 which includes the first soft magnetic layer 2 of CoFeTaZr, the nonmagnetic spacer layer 3 of Ru, and the second soft magnetic layer 4 of CoFeTaZr which is antiferromagnetically coupled (AFC) via the nonmagnetic spacer layer 3 on the disk substrate 1, and the intermediate layer 6 of Ru, the magnetic recording layer 7 of CoCrPt—SiO₂, the protection layer 8, and the lubrication layer (not shown) which are sequentially formed on the SUL 5, and the strength (Hbias) of the exchange coupling magnetic field which represents the degree of the AFC between the second soft magnetic layer 4 and the first soft magnetic layer 2 decreases from the inner circumferential area toward the outer circumferential area of the disk-like magnetic recording medium.

In the process of forming the nonmagnetic spacer layer in the example 1, as shown in FIG. 7, in the film deposition device, the disk-like sputtering target 22b which has an opening in the center and the oxide layer 22a which is provided in the opening are opposed to the disk substrate 21. The outer diameter of the sputtering target 22b is greater than the outer diameter of the disk substrate 21 and is, for example, 120 mm to 285 mm. The disk-like oxide layer 22a is formed of an oxide such as TiO₂, SiO₂, Al₂O₃ or MgO, and the sputtering target 22b which is formed of the material of the nonmagnetic spacer layer is provided around the disk-like oxide layer 22a. The outer diameter of the disk-like oxide layer 22a is less than the outer diameter of the disk substrate 21 and is, for example, 42.5 mm to 77.5 mm.

The thickness of the nonmagnetic spacer layer in the outer circumferential area is 1.5 nm, and the exchange coupling magnetic field (Hbias) is 50 Oe, while the thickness of the nonmagnetic spacer layer in the inner circumferential area is 1.0 nm, and Hbias is 135 Oe.

In the perpendicular magnetic recording medium of the example 1, the thickness of the nonmagnetic spacer layer increases from the inner circumferential area toward the outer circumferential area of the disk, and the strength (Hbias) of the exchange coupling magnetic field decreases from the inner circumferential area toward the outer circumferential area of the disk-like magnetic recording medium.

In FIG. 7, except that the oxide layer 22a is formed of the same material as that of the sputtering target 22b and the sputtering time of the nonmagnetic spacer layer is changed from 3 seconds to 2 seconds, a magnetic recording medium of a comparative example 1 is obtained in the same manner as that of the example 1. In the obtained magnetic recording medium, Hbias is 135 Oe both in the outer circumferential area and in the inner circumferential area.

In FIG. 7, except that the oxide layer 22a is formed of the same material as that of the sputtering target 22b, a magnetic recording medium of a comparative example 2 is obtained in the same manner as that of the example 1. In the obtained magnetic recording medium, Hbias is 50 Oe both in the outer circumferential area and in the inner circumferential area.

The magnetic recording medium of each of the example 1, the comparative example 1 and the comparative example 2 is mounted on the magnetic recording and reproducing device, and the overwrite characteristics (OW1 and OW2), the linear recording density (BPI), the track recording density (TPI), and the areal recording density (ADC) which is expressed as a product of BPI and TPI are evaluated.

Note that the evaluation is carried out under the condition that, in the magnetic recording medium of 3.5 inches, the outer circumferential area is located in a radius of 44 mm, and the inner circumferential area is located in a radius of 19 mm.

In OW1, when an overwrite operation is performed at a frequency higher than that of a single frequency pattern which is recorded as a foundation, a ratio between signal output of the foundation before and after the overwrite operation is shown. As OW1 increases, the performance of the high-frequency write operation improves.

On the other hand, in OW2, when an overwrite operation is performed at a frequency lower than that of a single frequency pattern which is recorded as a foundation, a ratio between signal output of the foundation before and after the overwrite operation is shown. As OW2 increases, the performance of the low-frequency write operation improves.

The measurement results are shown in the following table 1.

TABLE 1

| | | | | | | | | Improvements with | | |
|---|---|---|---|---|---|---|---|---|---|---|
| | | | | | | | | respect to | | |
| | | | | | | | | comparative example 1 | | |
| | | Hbias | OW2 | OW1 | BPI | TPI | ADC | BPI | TPI | ADC |
| | | [Oe] | [dB] | [dB] | [kBPI] | [kTPI] | [Gbpsi] | gain | gain | gain |
| Outer | Comparative | 135 | 26.6 | 21.4 | 1900 | 380 | 722 | 0.0% | 0.0% | 0.0% |
| circumference | example 1 | | | | | | | | | |
| | Comparative | 50 | 28.7 | 22.9 | 1985 | 369 | 737 | 4.5% | −2.8% | 1.6% |
| | example 2 | | | | | | | | | |
| | Example 1 | 50 | 28.7 | 22.9 | 1985 | 369 | 737 | 4.5% | −2.8% | 1.6% |
| Inner | Comparative | 135 | 27.1 | 33.1 | 2310 | 387 | 893 | 0.0% | 0.0% | 0.0% |
| circumference | example 1 | | | | | | | | | |
| | Comparative | 50 | 29.2 | 33.8 | 2353 | 373 | 877 | 1.8% | −3.6% | −1.8% |
| | example 2 | | | | | | | | | |
| | Example 1 | 135 | 27.1 | 33.1 | 2310 | 387 | 893 | 0.0% | 0.0% | 0.0% |

In the outer circumferential area, both OW1 and OW2 are improved in each of the example 1 and the comparative example 2 with respect to the comparative example 1, and BPI is increased by 4.5%. On the other hand, as OW is improved, write bleeding in a track width direction is increased, and therefore TPI is reduced by 2.8%. However, since a large improvement is made in BPI in each of the example 1 and the comparative example 2 with respect to the comparative example 1, ADC is increased by 1.6%.

In the inner circumferential area, since Hbias of the example 1 is the same as that of the comparative example 1, the performance remains the same. In the comparative example 2, although both OW1 and OW2 are improved with respect to the comparative example 1, since the circumferential speed of the inner circumferential area is lower than that of the outer circumferential area, the improvement in OW1 is small, and the improvement in BPI is also small as compared to the outer circumferential area and the increase remains at 1.8%. On the other hand, the write bleeding in the track width direction is greatly influenced by OW2 of the performance of the low-frequency write operation, and TPI is reduced by 3.6%. In the comparative example 2, ADC is reduced by 1.8%.

As compared to the comparative example 1, the example 1 shows an increase of 1.6% in ADC in the outer circumferential area and the inner circumferential area in total, and also shows an improvement in BPI in the outer circumferential area.

As compared to the comparative example 1, the comparative example 2 shows an improvement in BPI in the outer circumferential area but also shows a decrease of 0.2% in ADC in the outer circumferential area and the inner circumferential area in total.

The above results show that, when Hbias of the outer circumferential area is lower than that of the inner circumferential area, BPI improves while the capacity remains the same or improves.

Next, when the sputtering time of the nonmagnetic spacer layer is changed from 2 seconds to 3 seconds and Hbias of the inner circumferential area is changed from 135 Oe to 30 Oe, BPI of the outer circumferential area is measured. A condition for the upper limit of Hbias of the outer circumferential area which can improve BPI in the outer circumferential area and will not degrade ADC in the outer circumferential area and the inner circumferential area in total are examined.

FIG. 11 is a graph showing the relationship between Hbias of the inner circumferential area and the maximum value of Hbias of the outer circumferential area under the condition that ADC will not be degraded.

Hbias (ID_Hbias) of the inner circumferential area is plotted on the horizontal axis, and the upper limit of Hbias (OD_Hbias) of the outer circumferential area under the condition that ADC in the outer circumferential area and the inner circumferential area in total will not be degraded is plotted on the vertical axis, and a graph 101 is obtained.

As shown in the graph 101, since the upper limit of the OD_Hbias under the condition changes linearly with respect to the ID_Hbias, the upper limit of the OD_Hbias with respect to the ID_Hbias can be set within a range which satisfies the following inequality (1):

OD_Hbias<1.16×ID_Hbias−22.8 (1)

where ID_Hibas≥30.

### Example 2

An Al alloy substrate of 3.5 inches is accommodated in a film deposition chamber of a DC magnetron sputtering device, and an air is discharged from the film deposition chamber.

Next, inert gas such as Ar gas is introduced into the film deposition chamber, and on an Al alloy substrate, a soft magnetic undercoating layer (SUL) which is composed of a first soft magnetic layer of CoFeTaZr, a nonmagnetic spacer layer, and a second soft magnetic layer of CoFeTaZr is formed, and on the SUL, an intermediate layer and a magnetic recording layer of CoCrPt—SiO₂ are sequentially formed.

After that, a DLC protection layer is formed by a CVD method, a lubricant is applied by a dipping method, and a magnetic recording medium is obtained.

The obtained perpendicular magnetic recording medium has a structure similar to the structure shown in FIG. 2, and is composed of a multilayer structure of the Al alloy substrate 1, the soft magnetic undercoating layer (SUL) 5 which includes the first soft magnetic layer 2 of CoFeTaZr, the nonmagnetic spacer layer 3 of Ru and the second soft magnetic layer 4 of CoFeTaZr which is antiferromagnetically coupled (AFC) via the nonmagnetic spacer layer 3 sequentially on the Al alloy substrate 1, and the intermediate layer 6 of Ru, the magnetic recording layer 7 of CoCrPt—SiO₂, the protection layer 8, and the lubrication layer (not shown) which are sequentially formed on the SUL 5, and the strength (Hbias) of the exchange coupling field which represents the degree of the AFC between the second soft magnetic layer 4 and the first soft magnetic layer 2 decreases from the inner circumferential area toward the outer circumferential area of the disk-like magnetic recording medium.

In the process of forming the nonmagnetic spacer layer in the example 2, as shown in FIG. 4, in the film deposition device, the disk substrate 29 of 3.5 inches and the sputtering target 30 whose outer diameter is slightly less than the outer diameter of the disk substrate 29 and is, for example, 42.5 mm to 77.5 mm are opposed to each other.

The thickness of the nonmagnetic spacer layer in the outer circumferential area is 0.5 nm, and the exchange coupling magnetic field (Hbias) is 50 Oe, while the thickness of the nonmagnetic spacer layer in the inner circumferential area is 1.0 nm, and Hbias is 135 Oe. In the magnetic recording medium of the comparative example 1, Hbias is 135 Oe both in the outer circumferential area and in the inner circumferential area. In the magnetic recording medium of the comparative example 2, Hbias is 50 Oe both in the outer circumferential area and in the inner circumferential area.

The magnetic recording medium of each of the example 1, the comparative example 1 and the comparative example 2 is mounted on the magnetic recording and reproducing device, and the overwrite characteristics (OW1 and OW2), the linear recording density (BPI), the track recording density (TPI), and the areal recording density (ADC) which is expressed as a product of BPI and TPI are evaluated. Note that the evaluation is carried out under the condition that the outer circumferential area is located in a radius of 44 mm, and the inner circumferential area is located in a radius of 19 mm.

The measurement results are shown in the following table 2.

TABLE 2

| | | | | | | | | Improvements with | | |
|---|---|---|---|---|---|---|---|---|---|---|
| | | | | | | | | respect to | | |
| | | | | | | | | comparative example 1 | | |
| | | Hbias | OW2 | OW1 | BPI | TPI | ADC | BPI | TPI | ADC |
| | | [Oe] | [dB] | [dB] | [kBPI] | [kTPI] | [Gbpsi] | gain | gain | gain |
| Outer | Comparative | 135 | 26.6 | 21.4 | 1900 | 380 | 722 | 0.0% | 0.0% | 0.0% |
| circumference | example 1 | | | | | | | | | |
| | Comparative | 50 | 28.7 | 22.9 | 1985 | 369 | 737 | 4.5% | −2.8% | 1.6% |
| | example 2 | | | | | | | | | |
| | Example 2 | 50 | 28.7 | 22.9 | 1985 | 369 | 737 | 4.5% | −2.8% | 1.6% |
| Inner | Comparative | 135 | 27.1 | 33.1 | 2310 | 387 | 893 | 0.0% | 0.0% | 0.0% |
| circumference | example 1 | | | | | | | | | |
| | Comparative | 50 | 29.2 | 33.8 | 2353 | 373 | 877 | 1.8% | −3.6% | −1.8% |
| | example 2 | | | | | | | | | |
| | Example 2 | 135 | 27.1 | 33.1 | 2310 | 387 | 893 | 0.0% | 0.0% | 0.0% |

In the outer circumferential area, both OW1 and OW2 are improved in each of the example 2 and the comparative example 2 with respect to the comparative example 1, and BPI is increased by 4.5%. On the other hand, as OW is improved, the write bleeding in the track width direction is increased, and therefore TPI is reduced by 2.8%. However, since a large improvement is made in BPI in each of the example 2 and the comparative example 2 with respect to the comparative example 1, ADC is increased by 1.6%.

In the inner circumferential area, since Hbias of the example 2 is the same as that of the comparative example 1, the performance remains the same. In the comparative example 2, although both OW1 and OW2 are improved with respect to the comparative example 1, since the circumferential speed of the inner circumferential area is lower than that of the outer circumferential area, the improvement in OW1 is small, and the improvement in BPI is also small as compared to the circumference and the increase remains at 1.8%. On the other hand, the write bleeding in the track width direction is greatly influenced by OW2 of the performance of the low-frequency write operation, and TPI is reduced by 3.6%. In the comparative example 2, ADC is reduced by 1.8%.

As compared to the comparative example 1, the example 2 shows an increase of 1.6% in ADC in the outer circumferential area and the inner circumferential area in total, and also shows an improvement in BPI in the outer circumferential area. As compared to the comparative example 1, the comparative example 2 shows an increase in BPI in the outer circumferential area but also shows a decrease of 0.2% in ADC in the outer circumferential area and the inner circumferential area in total.

The above results show that, when Hbias of the outer circumferential area is lower than that of the inner circumferential area, BPI improves while the capacity remains the same or improves.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk-like magnetic recording medium comprising:
a disk-like substrate;
a first soft magnetic layer provided on the disk-like substrate;
a nonmagnetic spacer layer provided on the first soft magnetic layer;
a second soft magnetic layer provided on the nonmagnetic spacer layer and antiferromagnetically exchange-coupled with the first soft magnetic layer via the nonmagnetic spacer layer; and
a magnetic recording layer provided on the second soft magnetic layer, wherein
strength of an exchange coupling magnetic field Hbias decreases from an inner circumferential area toward an outer circumferential area of the disk-like magnetic recording medium.

2. The disk-like magnetic recording medium of claim 1, wherein the strength of the exchange coupling magnetic field Hbias decreases gradually from the inner circumference area toward the outer circumferential area.

3. The disk-like magnetic recording medium of claim 1, wherein an exchange coupling magnetic field OD_Hbias of the outer circumferential area and an exchange coupling magnetic field ID_Hbias of the inner circumferential area satisfy a relationship expressed as an inequality (1):
OD_Hbias<1.16×ID_Hbias−22.8 (1)
where ID_Hbias≥30.

4. The disk-like magnetic recording medium of claim 1, wherein a value of the exchange coupling magnetic field Hbias periodically changes with respect to a thickness of the nonmagnetic spacer layer, and a thickness x of the nonmagnetic spacer layer decreases from the inner circumferential area toward the outer circumferential area and satisfies a relationship expressed as 0<x≤a where a is a thickness of the nonmagnetic spacer layer at a first peak at which the exchange coupling magnetic field Hbias has a maximum value.

5. The disk-like magnetic recording medium of claim 4, wherein the thickness x of the nonmagnetic spacer layer decreases gradually from the inner circumferential area toward the outer circumferential area.

6. The disk-like magnetic recording medium of claim 1, wherein a value of the exchange coupling magnetic field Hbias periodically changes with respect to a thickness of the nonmagnetic spacer layer, and a thickness x of the nonmagnetic spacer layer increases from the inner circumferential area toward the outer circumferential area of the disk-like magnetic recording medium and satisfies a relationship expressed as a≤x<b where a is a thickness of the nonmagnetic spacer layer at a first peak at which the exchange coupling magnetic field Hbias has a maximum value, c is a thickness of the nonmagnetic spacer layer at a second peak at which the exchange coupling magnetic field Hbias has a maximum value after the first peak, and b is a thickness of the nonmagnetic spacer layer when the exchange coupling magnetic field Hbias has a minimum value between the first peak and the second peak.

7. The disk-like magnetic recording medium of claim 6, wherein the thickness x of the nonmagnetic spacer layer increases gradually from the inner circumferential area toward the outer circumferential area.

8. A disk-like magnetic recording medium comprising:
a disk-like substrate;
a first soft magnetic layer provided on the disk-like substrate;
a nonmagnetic spacer layer provided on the first soft magnetic layer;
a second soft magnetic layer provided on the nonmagnetic spacer layer and antiferromagnetically exchange-coupled with the first soft magnetic layer via the nonmagnetic spacer layer; and
a magnetic recording layer provided, on the second soft magnetic layer, wherein
a value of an exchange coupling magnetic field Hbias periodically changes with respect to a thickness of the nonmagnetic spacer layer, and
a thickness x of the nonmagnetic spacer layer increases from an inner circumferential area toward an outer circumferential area of the disk-like magnetic recording medium and satisfies a relationship expressed as a≤x<b where a is a thickness of the nonmagnetic spacer layer at a first peak at which the exchange coupling magnetic field Hbias has a maximum value, c is a thickness of the nonmagnetic spacer layer at a second peak at which the exchange coupling magnetic field Hbias has a maximum value after the first peak, and b is a thickness of the nonmagnetic spacer layer when the exchange coupling magnetic field Hbias has a minimum value between the first peak and the second peak.

9. The disk-like magnetic recording medium of claim 8, wherein the thickness x of the nonmagnetic spacer layer increases gradually from the inner circumferential area toward the outer circumferential area.

10. A magnetic recording and reproducing device comprising:
a disk-like magnetic recording medium comprising:
a disk-like substrate;
a first soft magnetic layer provided on the disk-like substrate;
a nonmagnetic spacer layer provided on the first soft magnetic layer;
a second soft magnetic layer provided on the nonmagnetic spacer layer and antiferromagnetically exchange-coupled with the first soft magnetic layer via the nonmagnetic spacer layer; and
a magnetic recording layer provided on the second soft magnetic layer, wherein
strength of an exchange coupling magnetic field Hbias decreases from an inner circumferential area toward an outer circumferential area of the disk-like magnetic recording medium;
a driver which rotates the recording medium; and
a magnetic head which includes a recording head which performs information processing with respect to the recording medium.

11. The magnetic recording and reproducing device of claim 10, wherein the strength of the exchange coupling magnetic field Hbias decreases gradually from the inner circumferential area toward the outer circumferential area.

12. The magnetic recording and reproducing device of claim 10, wherein an exchange coupling magnetic field OD_Hbias of the outer circumferential area and an exchange coupling magnetic field ID_Hbias of the inner circumferential area satisfy a relationship expressed as an inequality (1):
OD_Hbias<1.16×ID_Hbias−22.8 (1)
where ID_Hbias≥30.

13. The magnetic recording and reproducing device of claim 10, wherein a value of the exchange coupling magnetic field Hbias periodically changes with respect to a thickness of the nonmagnetic spacer layer, and a thickness x of the nonmagnetic spacer layer decreases from the inner circumferential area toward the outer circumferential area and satisfies a relationship expressed as 0<x≤a where a is a thickness of the nonmagnetic spacer layer at a first peak at which the exchange coupling field Hbias has a maximum value.

14. The magnetic recording and reproducing device of claim 13, wherein the thickness x of the nonmagnetic spacer layer decreases gradually from the inner circumferential area toward the outer circumferential area.

15. The magnetic and recording device of claim 10, wherein a value of the exchange coupling magnetic field Hbias periodically changes with respect to a thickness of the nonmagnetic spacer layer, and a thickness x of the nonmagnetic spacer layer increases from the inner circumferential area toward the outer circumferential area and satisfies a relationship expressed as a≤x<b where a is a thickness of the nonmagnetic spacer layer at a first peak at which the exchange coupling magnetic field Hbias has a maximum value, c is a thickness of the nonmagnetic spacer layer at a second peak at which the exchange coupling magnetic field Hbias has a maximum value after the first peak, and b is a thickness of the nonmagnetic spacer layer when the exchange coupling magnetic field Hbias has a minimum value between the first peak and the second peak.

16. The magnetic recording and reproducing device of claim 15, wherein the thickness x of the nonmagnetic spacer layer increases gradually from the inner circumferential area toward the outer circumferential area.

17. A magnetic recording and reproducing device comprising:
a disk-like magnetic recording medium comprising:
a disk-like substrate;
a first soft magnetic layer provided on the disk-like substrate;
a nonmagnetic spacer layer provided on the first soft magnetic layer;
a second soft magnetic layer provided on the nonmagnetic spacer layer and antiferromagnetically exchange-coupled with the first soft magnetic layer via the nonmagnetic spacer layer; and
a magnetic recording layer provided on the second soft magnetic layer, wherein
a value of an exchange coupling magnetic field Hbias periodically changes with respect to a thickness of the nonmagnetic spacer layer, and
a thickness x of the nonmagnetic spacer layer increases from the inner circumferential area toward the outer circumferential area and satisfies a relationship expressed as a≤x<b where a is a thickness of the nonmagnetic spacer layer at a first peak at which the exchange coupling magnetic field Hbias has a maximum value, c is a thickness of the nonmagnetic spacer layer at a second peak at which the exchange coupling magnetic field Hbias has a maximum value after the first peak, and b is a thickness of the nonmagnetic spacer layer when the exchange coupling magnetic field Hbias has a minimum value between the first peak and the second peak;
a driver which rotates the recording medium; and
a magnetic head which includes a recording head which performs information processing with respect to the recording medium.

18. The magnetic recording and reproducing device of claim 17, wherein the thickness x of the nonmagnetic spacer layer increases gradually from the inner circumferential area toward the outer circumferential area.
